(19) United States
(12) Patent Application Publication
(10) Pub. No.: US 2004/0127130 A1
(43) Pub. Date: Jul. 1, 2004

(54) Magnetic material-nanomaterial heterostructural nanorod

(76) Inventors: Gyu Chul Yi, Pohang-city (KR); Suk Woo Jung, Pohang-city (KR)

Correspondence Address: ROTHWELL, FIGG, ERNST & MANBECK, P.C., 1425 K STREET, N.W., SUITE 800, WASHINGTON, DC, 20005, US

(21) Appl. No.: 10/461,455

(22) Filed: Jun. 16, 2003

(30) Foreign Application Priority Data
Dec. 28, 2002 (KR) 2002-85900

(51) Int. Cl. D04H 1/00; D04H 3/00; D04H 5/00; D04H 13/00; B32B 15/14; B32B 27/12; H01F 1/00

(52) U.S. Cl. 442/376; 442/339; 442/394; 442/343; 442/349; 442/377; 442/378; 442/379

(57) ABSTRACT

A magnetic material-nanomaterial heterostructural nanorod is provided. The magnetic material-nanomaterial heterostructural nanorod includes a nanomaterial template and a magnetic material. As the magnetic material, the film of a mono-compositional magnetic metal, magnetic ceramic, a multi-compositional magnetic metal, or magnetic ceramic alloy can be deposited on the tip of the nanomaterial template.

### BACKGROUND OF THE INVENTION

This application claims the priority of Korean Patent Application No. 2002-85900, filed on Dec. 28, 2002, in the Korean Intellectual Property Office, the disclosure of which is incorporated herein in its entirety by reference.

1. Field of the Invention

The present invention relates to a heterostructural nanorod, and more particularly, to a magnetic material-nanomaterial heterostructural nanorod, which is useful for magnetic device applications.

2. Description of the Related Art

As the size of devices decreases, a conventional top-down etching process becomes inapplicable. Therefore, conversion of a top-down process into a bottom-up process for manufacturing desirable nanodevices at the atomic or molecular level is required. In order to manufacture nanodevices using a bottom-up process, it is essential to develop a technique capable of incorporating a desirable nanostructure into a single device.

One-dimensional heterostructural nanorods are potentially ideal functional components for nanoscale electronics and optoelectronics. Semiconductor heterostructural nanorods have already exhibited tunable wavelength in light emission due to the quantum confinement effect, useful for many nanoscale devices. Furthermore, the ability to fabricate nanoscale heterostructures opens up many new device applications as already proven in microscale electronics and photonics. A prime example of the nanoscale heterostructures is magnetic random access memory, which is based on a magnetic material-nanomaterial heterostructure that exploits both the spin and charge of the carriers. The combination of the two degrees of freedom promises new functionality in memory devices, detectors, and light-emitting sources. Hence, fabrication of magnetic material-nanomaterial heterostructural nanorods is of particular interest in nanoscale spintronics. Controlled growth of nanoscale magnetic layers on a single nanorod would enable novel physical properties such as size-dependent magnetism to be exploited, which offers the tuning of remanent magnetization and coercive fields by varying the magnetic layer thickness. The ability to prepare tunable magnetic metal/nanomaterial heterostructural nanorods is expected to greatly increase the versatility and power of these building blocks for applications in nanoscale spintronics.

Conventionally, a method for arraying magnetic nanowires is known in the art. According to this method, a nanopattern formed using electron beam lithography is b-dry etched to obtain nanowire arrays. However, there arise many problems due to changes in surface atoms upon dry etching.

Meanwhile, in a magnetic nanowire formation by electrodeposition, a porous cationic material serves as a template for nucleation. In the electrodeposition method, when molten magnetic metals are incorporated into the pores of the porous cationic material, the magnetic metals electrochemically grow in a single direction into magnetic nanostructures. When compared to the electron beam lithography, such electrodeposition is advantageous in that the size of nanowires can be easily controlled and nanowires which have sizes of several tens of nanometers can be formed. However, such electrodeposition can be carried out only on specific substrates, and it is difficult to prepare solutions for multi-compositional magnetic metals. In addition, it is difficult to apply electrodeposition for the preparation of non-conducting magnetic ceramics.

In addition to the magnetic nanowires, magnetic nanoparticles also have the very specific magnetic property, i.e., as the sizes of the nanoparticles are decreased to a specific range, generally 10-100 nm, they have maximum magnetic properties. Recently, study reports have disclosed that when uniform, spherical, magnetic metal nanoparticles, which have maximum magnetic properties are arrayed in a regular pattern, these individual particles can be used as bits. However, there are many problems in developing nanodevices using these magnetic particles. In particular, it is difficult to manufacture nanoparticles with uniform density and size and to apply such particles to devices using conventionally available magnetic films.

### SUMMARY OF THE INVENTION

The present invention provides a magnetic material-nanomaterial heterostructural nanorod, prepared by uniformly distributing magnetic nanoparticles at a high density, which can be used for magnetic devices due to both semiconductor and magnetic properties of the heterostructure.

According to an aspect of the present invention, there is provided a magnetic material-nanomaterial heterostructural nanorod comprising a nanomaterial template and a magnetic material film.

According to another aspect of the present invention, there is provided a magnetic material-nanomaterial heterostructural nanorod array comprising a substrate, nanomaterial templates and magnetic material films.

According to still another aspect of the present invention, there is provided a magnetic device using said magnetic material-nanomaterial heterostructural nanorod array.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram showing the process for manufacturing a magnetic material-nanomaterial heterostructural nanorod array according to the present invention;

FIG. 2A is a scanning electron microscopy (SEM) photograph of zinc oxide (ZnO) nanomaterial template before the deposition of the magnetic material films;

FIGS. 2B, 2C, and 2D are SEM photographs of ZnO nanorods, on which films of Fe (2B), Co (2C), and Ni (2D) are deposited, respectively;

FIGS. 3A and 3B are an atomic force microscopic (AFM) image of Ni film-deposited ZnO nanorods (3A), and a magnetic force microscopic (MFM) image of Ni film-deposited ZnO nanorods (3B), respectively;

FIGS. 4A and 4B are a synchrotron-radiation XRD θ-2θ scan result of Ni film-deposited ZnO nanorods (4A), and a TEM image of Ni film-deposited ZnO nanorods (4B), respectively; and

FIGS. 5A, 5B and 5C are a hysteresis curve of Ni film-deposited ZnO nanorods (5A), room temperature M-H curves of Ni film-deposited ZnO nanorods with a Ni layer thickness of 5 and 10 nm (5B), and room temperature M-H curves of Ni film-deposited ZnO nanorods with a Ni layer thickness of 20, 30, and 40 nm (5C), respectively.

### DETAILED DESCRIPTION OF THE INVENTION

Hereinafter, the present invention will be described in more detail.

As described above, the present invention provides a magnetic material-nanomaterial heterostructural nanorod comprising a nanomaterial template and a magnetic material film.

Examples of the nanomaterial template include ZnO, GaN, Si, InP, GaP, ZnSe, ZnS, CdSe, CdS, InAs, GaAs, Ge, and an alloy thereof, and carbon nanotubes. Preferably, ZnO, GaN, Si, and InP are used.

Examples of the magnetic material film include Fe, Co, Ni, Mn, Gd, an alloy thereof, and ferrite. Also other conventional magnetic materials can be used. Preferably, Fe, Co, Ni, and an alloy thereof are used.

The nanomaterial template can be grown in a single direction on a substrate or can be etched in a single direction.

According to one embodiment of the present invention, a nanomaterial template is grown on a substrate in a one direction, preferably in a vertical direction. Then, a magnetic material film is selectively deposited on the tip of the nanomaterial template using one of various deposition methods to form a magnetic material-nanomaterial heterostructural nanorod.

The nanomaterial template can be grown using a nanomaterial growth method, preferably, metal organic chemical vapor deposition.

The magnetic material film can be deposited using a conventional method including a physical method such as sputtering, thermal or e-beam evaporation, pulse laser deposition, and molecular beam epitaxy and a chemical method such as chemical vapor deposition.

Also, the present invention provides a magnetic material-nanomaterial heterostructural nanorod array comprising a substrate, nanomaterial templates and magnetic material films.

And there is provided a magnetic device using the magnetic material-nanomaterial heterostructural nanorod array.

The magnetic material-nanomaterial heterostructural nanorod of the present invention may be used for a magnetic device in various magnetic recording media such as hard disks. By using the heterostructural nanorod of the present invention, a uniform, high-density magnetic device with the improved properties can be manufactured. The thus manufactured magnetic device can substitute magnetic films, used as current recording media for information recording media, and has a recording density of 100 Gbit/inch² or more, and further, 10³ Gbit/inch² grade.

In particular, the magnetic material-nanomaterial heterostructural nanorod of the present invention can be used for magnetic random access memory (MRAM) since the MRAM is based on a magnetic material-nanomaterial heterostructure that exploits both the spin and charge of the carriers. The combination of the two degrees of freedom promises new functionality in memory devices, detectors, and light-emitting sources. Hence, fabrication of magnetic material-nanomaterial heterostructural nanorod is of particular interest in nanoscale spintronics. Furthermore, magnetic sensors and biological and chemical sensors can be fabricated using the heterostructural nanorod.

Hereinafter, the magnetic material-nanomaterial heterostructural nanorod of the present invention will be described in more detail.

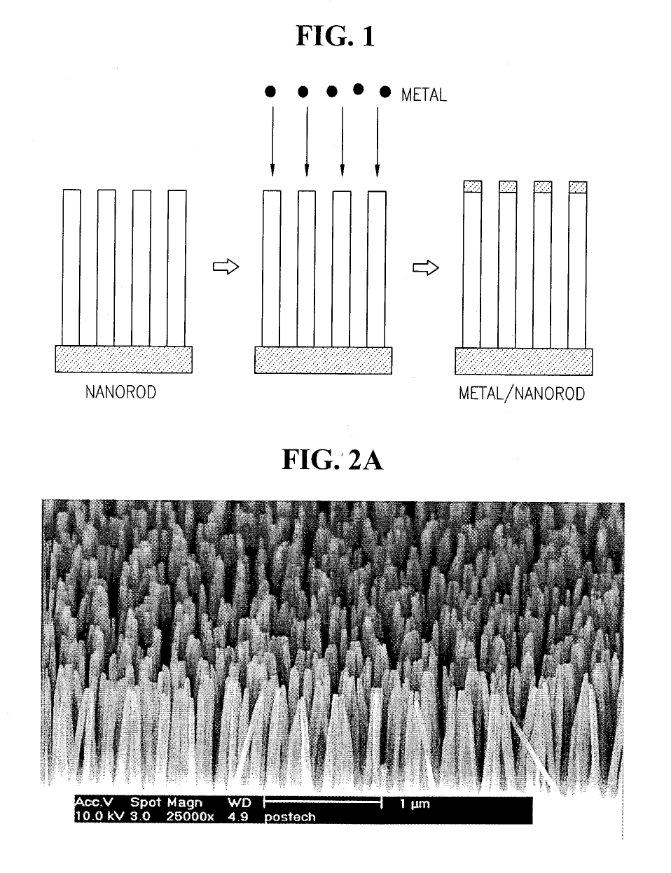

FIG. 1 schematically shows the process for forming the magnetic material-nanomaterial heterostructural nanorod array of the present invention.

1) Growth of Nanomateial Templates

There are no particular limitations to the nanomaterial template, provided that the nanomaterial template can be grown in a vertical or a single direction or can be etched in a single direction. Examples of the nanomaterial template include ZnO, GaN, Si, InP, GaP, ZnSe, ZnS, CdSe, CdS, InAs, GaAs, Ge, and their alloys as well as carbon nanotubes. Preferably, ZnO, GaN, Si, and InP are used.

The nanomaterial template can be grown using a nanorod growth method, preferably, metal organic chemical vapor deposition. For example, the process for preparing the heterostructural nanorod of the present invention using zinc oxide (ZnO) as the nanomaterial template will now be described.

First, reactants comprising a zinc-containing organic metal and an oxygen-containing gas or an oxygen-containing organic substance are supplied into a reactor via respective supply lines at a flow rate of 10-100 sccm and 1-10 sccm, respectively. The reactants are reacted with each other under an atmospheric pressure or less and at a temperature of 1,200° C. or less and deposited on a substrate using metal-organic chemical vapor deposition. While the nanomaterial template grow, the reactor is maintained to have a pressure of several tens to several hundreds mTorr and a temperature of 200 to 700° C. As a result, ZnO nanomaterial template can be prepared.

The substrate to be used herein may be glass, sapphire, silicon, Al₂O₃, and so forth. Argon or nitrogen may be used as a carrier for the above gases. Preferably, argon is used.

2) Deposition of Magnetic Material Films

Magnetic material films are deposited on the nanomaterial template prepared in the above 1), thereby forming the magnetic material-nanomaterial heterostructural nanorod array.

The magnetic material films can be deposited using a conventional method including a physical method such as sputtering, thermal or e-beam evaporation, pulse laser deposition, and molecular beam epitaxy and a chemical method such as chemical vapor deposition.

In the case of using e-beam evaporation, films of Fe-, Co- or Ni-based magnetic materials are deposited on the nanomaterial template until the thickness of each magnetic material film is in the range of 5-50 nm. Preferably, metal evaporation is carried out using an electron beam with an acceleration voltage of −4.59 kV and an emission current of 30-50 mA.

When needed, the magnetic material film-deposited heterostructural nanorod array may be heat-treated. The heat treatment improves the magnetic properties of the heterostructural nanorod array, in particular, the interfaces between the magnetic material films and the nanomaterial templates become very distinct and the crystallinity of the magnetic material film can be improved. Although there are no particular limitations to the conditions for the heat treatment, the heat treatment may be carried out at a temperature range of 200-1,000° C. for a time range of 1 minute to 10 hours.

Heterostructural nanorod array of the present invention have advantages such as accurate control of magnetic layer thickness, controlled magnetic property, and both use of magnetic and semiconductor properties. In addition, selective deposition of magnetic material films on the tips of the nanomaterial template offers very distinct interfaces between the magnetic material films and the nanomaterial templates. Furthermore, because various magnetic materials and alloys thereof can be used to prepare heterostructural nanorod array of the present invention, the prepared heterostructural nanorod array can be efficiently used in various magnetic devices for various recording media and spintronic devices as well as sensors.

Hereinafter, the present invention will be described more specifically by examples. However, the following examples are provided only for illustrations and thus the present invention is not limited to or by them.

### EXAMPLE 1

ZnO nanomaterial templates were prepared on a sapphire substrate using a metal organic chemical vapor deposition apparatus according to the following procedure. Diethyl zinc and O₂ gases were used as reactants and argon was used as a carrier gas.

The O₂ and diethyl zinc gases were supplied into a reactor via respective supply lines at a flow rate of about 20 sccm and about 2 sccm, respectively. The reactants were reacted and deposited on the substrate for about one hour to thereby grow ZnO nanomaterial templates. While the nanomaterial templates grow, the reactor was maintained to have a pressure of about 50 mtorr and a temperature of 450° C.

Next, Fe-based magnetic material films were deposited on the prepared nanomaterial templates using e-beam evaporation until the average thickness of the films was 30 nm to thereby form magnetic material-nanomaterial heterostructural nanorod array. Fe evaporation was carried out at an acceleration voltage of −4.59 kV and an emission current of 30 mA, a reactor pressure was maintained at about 10-5 mmHg, and a temperature of a substrate was maintained at a room temperature.

### EXAMPLE 2

Magnetic material-nanomaterial heterostructural nanorod array was prepared in the same manner as in Example 1 except that Co-based magnetic material films were used.

### EXAMPLE 3

Magnetic material-nanomaterial heterostructural nanorod array was prepared in the same manner as in Example 1 except that Ni-based magnetic material films were used.

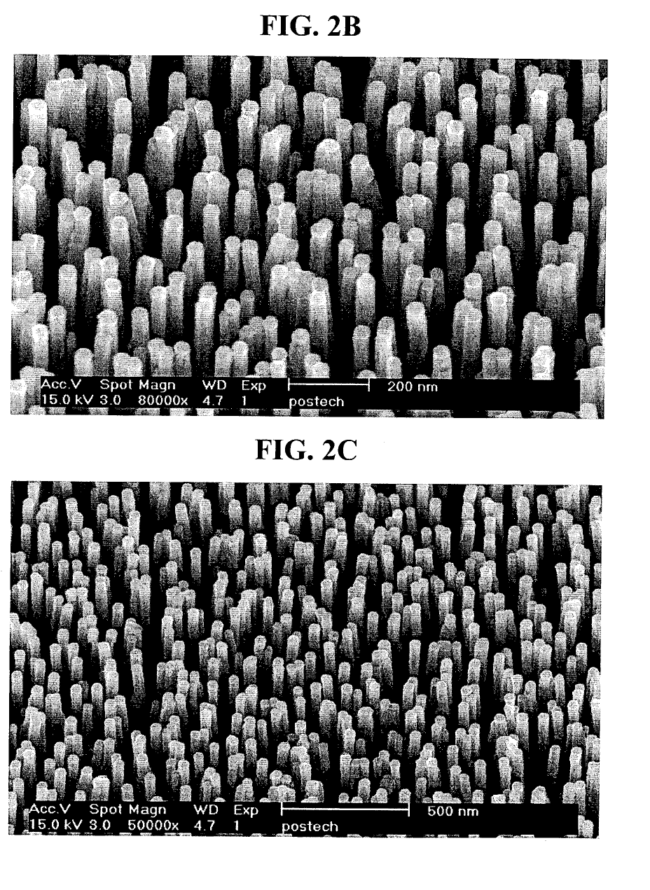

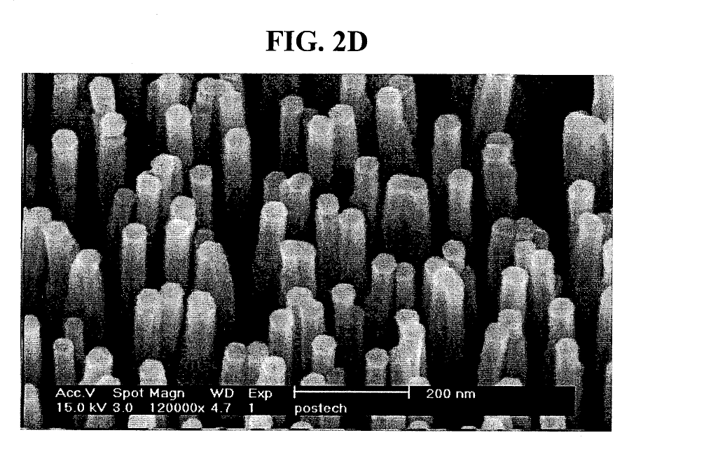

FIG. 2A shows a scanning electron microscopy (SEM) photograph of the ZnO nanomaterial templates before the deposition of the films of the magnetic materials in Example 1. FIGS. 2B, 2C, and 2D show SEM photographs of the magnetic material-nanomaterial heterostructural nanorod arrays of Examples 1, 2, and 3, respectively. As shown in FIGS. 2A through 2D, the magnetic material films were selectively deposited on the tips of the nanomaterial templates without causing large differences in diameters and shapes of the nanostructures.

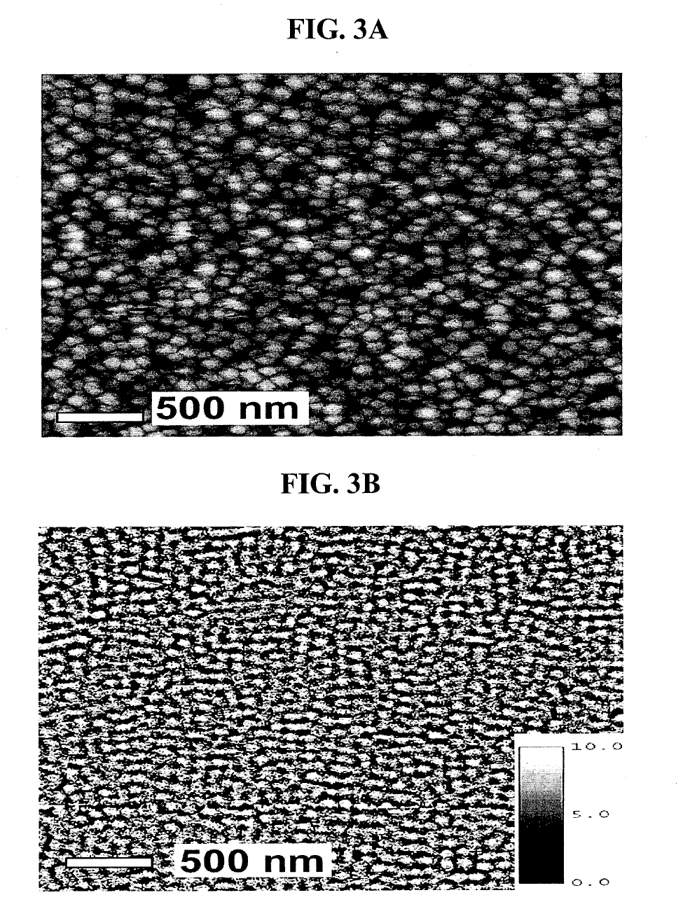

FIGS. 3A and 3B shows atomic force microscopic (AFM) and magnetic force microscopic (MFM) images of Ni/ZnO heterostructural nanorod arrays, respectively.

Prior to performing MFM measurements, samples were saturated with an applied magnetic field of 3000 Oe. As shown in FIG. 3B, the magnetic image from each nanorod tip clearly shows bright spots even under a zero magnetic field, resulting from strong magnetization on the nanorod tips.

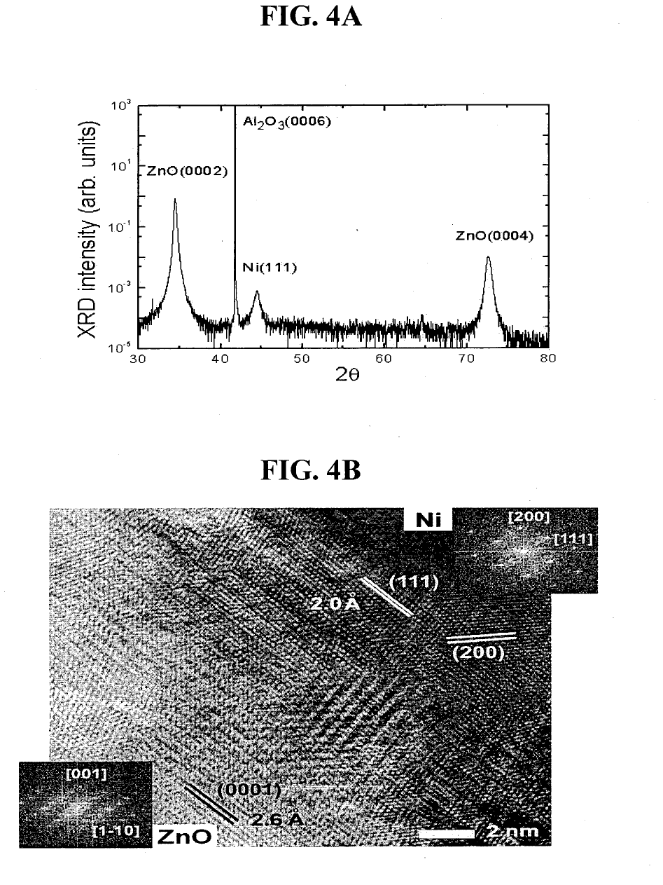

Crystal orientation of the Ni thin films on the nanorod arrays was investigated employing synchrotron radiation x-ray diffraction (SR-XRD). High flux from synchrotron radiation enables to measure XRD of very thin Ni layers on the nanorod arrays with enhanced sensitivity. FIG. 4A shows a typical SR-XRD θ-2θ scan result of Ni/ZnO heterostructural nanorod arrays. From the XRD data, a Ni (111) XRD peak was observed at 44.5° in addition to ZnO (0002), ZnO (0004), ZnO (0006) nanorod peaks and Al₂O₃ (0006) substrate peak. No significant XRD peak due to other planes of Ni was observed within a noise signal range of these measurements.

Observation of only the Ni (111) peak strongly suggests that most crystallized Ni grains were highly oriented with their [111] direction normal to the substrate.

The dominant formation of Ni (111) grains was also confirmed using transmission electron microscopy. As shown in FIG. 4B, the interface between Ni and ZnO has roughness of 2-5 nm, which results in many partial dislocations such as stacking faults or twins. Ni was grown as poly-crystalline, but most large grains had an FCC structure whose (111) plane is parallel to the basal plane of hexagonal ZnO nanorod array.

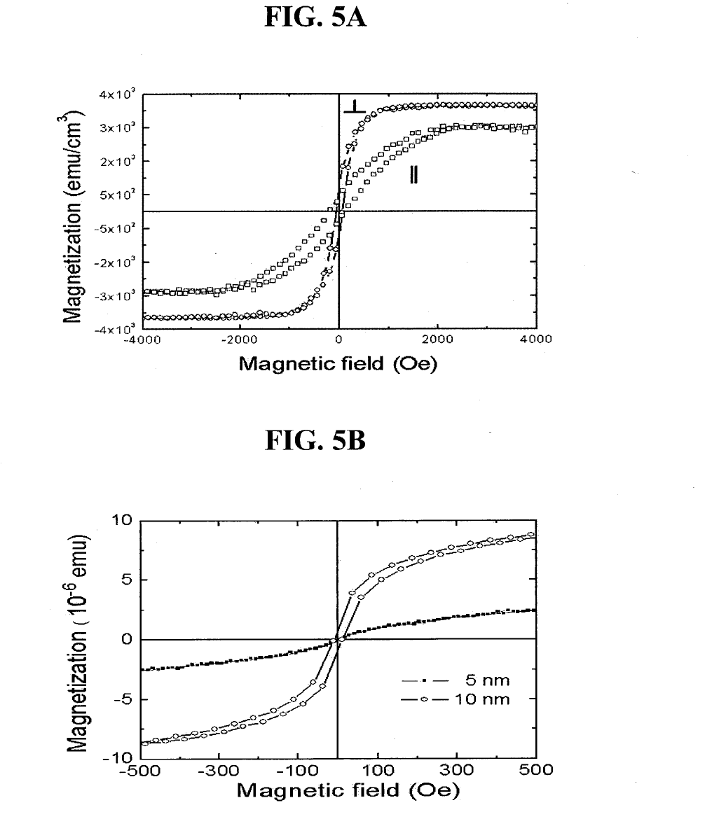

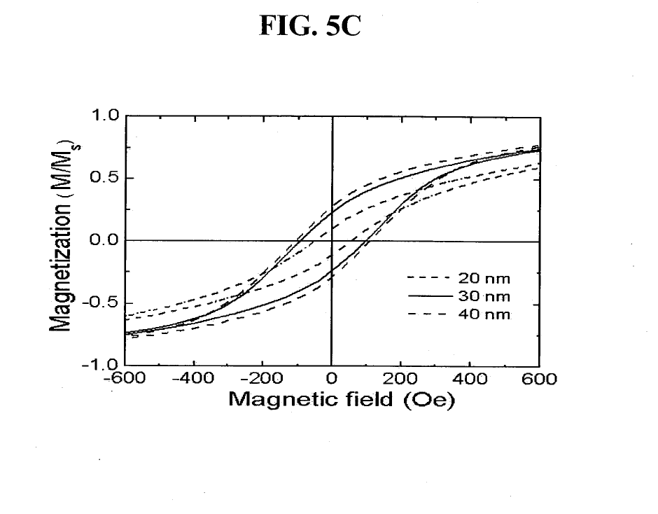

Magnetic properties of the heterostructural nanorod array were studied using both a superconducting quantum interference device magnetometer (SQUID) and an alternating gradient magnetometer (AGM). The magnetic properties of the Ni film-deposited ZnO heterostructural nanorod array of Example 3 were measured using a vibrating sample magnetometer (VSM). FIG. 5A shows magnetic hysteresis curves of the Ni film-deposited ZnO nanorod array when the orientation of an external applied magnetic field is parallel with and perpendicular to that of the nanorod array, respectively. When the orientation of the magnetic field was parallel with that of the nanorod array, a coercive force and a magnetization strength increased. This indicates that magnetized areas are regularly oriented along a major axis of the nanorod array.

FIG. 5B shows magnetic hysteresis (M−H) curves of Ni/ZnO heterostructural nanorod array with magnetic Ni layer thickness of 5 and 10 nm. For the Ni layer thickness of 10 nm, Ni/ZnO heterostructural nanorod array clearly shows a hysteresis loop at room temperature, resulting from ferromagnetic ordering in materials with the Curie temperature above room temperature. Magnetization for the Ni/ZnO heterostuctural nanorod array was saturated at 4000 Oe. The coercive field (H_{c}) and remanence ratio (ratio of remanent magnetization (Mᵣ) to saturation magnetization (Mₛ)) were 10 Oe and 7%, respectively. For the Ni layer thickness of 5 nm, however, the M-H curve of heterostructural nanorod array shows zero value in Mᵣ and H_{c}, presumably due to superparamagnetic behavior.

Thickness-dependent magnetic behavior of Ni/ZnO heterostuctural nanorod array was further investigated. FIG. 5C shows room temperature M-H curves of Ni/ZnO heterostuctural nanorod array with Ni layer thickness of 20, 30, and 40 nm. Heterostructural nanorod array with Ni layer thickness above 10 nm exhibited a clear hysteresis loop with nonzero values in Mᵣ and H_{c} due to their ferromagnetic behavior. The remanence ratio and magnetic coercive field of Ni/ZnO heterostructural nanorod array increased from 7% and 10 Oe to 29% and 110 Oe, respectively, by increasing the Ni layer thickness from 10 to 40 nm.

As is apparent from the above description, magnetic material-nanomaterial heterostructural nanorod array of the present invention has the film of a magnetic material selectively deposited on the tip of a nanomaterial template and a very distinct interface between the magnetic material films and the nanomaterial templates. Because various magnetic metals and alloys thereof can be used, a heterostructural nanorod array of the present invention can be efficiently used in magnetic devices for various magnetic recording media.

Controlled growth of Ni/ZnO heterostructural nanorod array of the present invention opens up significant opportunities for the fabrication of spintronic device structures on a single nanorod. The simple yet accurate thickness control allows tunable magnetic properties in nanosized magnetic layers on individual nanorods due to a crossover from superparamagnetism to ferromagnetism. These magnetic building blocks may be used as components for nanoscale spin-valve transistors, spin light-emitting diodes, and nonvolatile storage and logic devices. More generally, we believe that the simple “bottom up” heterostructural approach might readily be expanded to create many other magnetic-nanomaterial heterostructural nanorods.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A magnetic material-nanomaterial heterostructural nanorod comprising a nanomaterial template and a magnetic material film.

2. The magnetic material-nanomaterial heterostructural nanorod according to claim 1, wherein the nanomaterial template is one or more material selected from the group consisting of ZnO, GaN, Si, InP, GaP, ZnSe, ZnS, CdSe, CdS, InAs, GaAs, Ge and an alloy thereof, and a carbon nanotube.

3. The magnetic material-nanomaterial heterostructural nanorod according to claim 1, wherein the magnetic material film is one or more material selected from the group consisting of Fe, Co, Ni, Mn, Gd and an alloy thereof, and ferrite.

4. The magnetic material-nanomaterial heterostructural nanorod according to claim 1, wherein the nanomaterial template is grown in a single direction on a substrate or etched from a substrate.

5. The magnetic material-nanomaterial heterostructural nanorod according to claim 1, wherein the nanomaterial template is grown using metal organic chemical vapor deposition.

6. The magnetic material-nanomaterial heterostructural nanorod according to claim 1, wherein the magnetic material film is deposited on the tip of the nanomaterial template using sputtering, thermal or e-beam evaporation, pulse laser deposition, molecular beam epitaxy, or chemical vapor deposition.

7. A magnetic-nanomaterial heterostructural nanorod array comprising a substrate, nanomaterial templates and magnetic material films.

8. The magnetic material-nanomaterial heterostructural nanorod array according to claim 7, wherein the nanomaterial templates are one or more material selected from the group consisting of ZnO, GaN, Si, InP, GaP, ZnSe, ZnS, CdSe, CdS, InAs, GaAs, Ge and an alloy thereof, and a carbon nanotube.

9. The magnetic material-nanomaterial heterostructural nanorod array according to claim 7, wherein the magnetic material films are one or more material selected from the group consisting of Fe, Co, Ni, Mn, Gd and an alloy thereof, and ferrite.

10. The magnetic material-nanomaterial heterostructural nanorod array according to claim 7, wherein the nanomaterial templates are grown in a single direction on a substrate or etched from a substrate.

11. The magnetic material-nanomaterial heterostructural nanorod array according to claim 7, wherein the magnetic material films are deposited on the tip of the nanomaterial templates using sputtering, thermal or e-beam evaporation, pulse laser deposition, molecular beam epitaxy, or chemical vapor deposition.

12. A magnetic device using the magnetic material-nanomaterial heterostructural nanorod array according to any one of claims 7 to 11.

13. The magnetic device according to claim 12, wherein the magnetic device is selected from the group consisting of memory devices, detectors, and light-emitting sources.
